(19) United States
(12) Patent Application Publication
(10) Pub. No.: US 2002/0137374 A1
(43) Pub. Date: Sep. 26, 2002

(54) Modular ballast housing for a track lighting fixture

(76) Inventors: John O'Rourke, Downers Grove, IL (US); Franklin Fong, Wheeling, IL (US); James A. Rekowski, Prospect Heights, IL (US)

Correspondence Address: Kevin W. Guynn, SONNENSCHEIN NATH & ROSENTHAL, Sears Tower ,Wacker Drive Station, P.O. Box 061080, Chicago, IL, 60606-1080, US

(21) Appl. No.: 09/813,650

(22) Filed: Mar. 21, 2001

(51) Int. Cl. H01R 25/00

(52) U.S. Cl. 439/121

(57) ABSTRACT

A modular ballast housing for a track lighting fixture having a universal releasable connector that engages various types of lighting fixtures is disclosed.

### FIELD OF THE INVENTION

The present invention generally refers to a modular ballast housing for track lighting fixtures having a universal connector that engages various types of lighting fixtures.

### BACKGROUND OF THE INVENTION

Track lighting systems provide support and a source of electric power for lighting fixtures. Track lighting systems are often utilized in commercial establishments where individual lighting fixtures are utilized to highlight a particular item or area. Typically, it is both necessary and desirable to readjust the aiming of the light from a lighting fixture in both the vertical and horizontal directions. In lighting installations where a multiplicity of lighting fixtures are employed, such as in a retail environment, proper aiming is important to good visual merchandising. However, re-aiming, re-lamping, and cleaning may very likely be done by someone who does not have the requisite skills or appreciation of the art of good lighting.

Ceramic arc tube metal halide high intensity discharge lamps (CAMH) are a relatively new generation of high intensity discharge (HID) lamps used in track lighting systems and are known for their long life, stable color rendering throughout their life, and energy efficiency. These lamps are often used in environments where relatively powerful levels of illumination are desired, where long term energy cost is an issue, and where frequent re-lamping and re-aiming by unskilled users is undesirable. These lamps are most often used in retail and commercial settings but may also be employed in a residential setting as well. HID lamps require a ballast for initial ignition and ongoing electrical current control. Typically, the ballast is integral with or mounted to the light fixture. Therefore, if either the ballast or the light fixture needs to be re-lamped, both components must be removed from the track and repaired or replaced. Also, re-aiming may be difficult when the ballast is integral with the light fixture. Further, a ballast is typically the most costly component in track lighting systems. Therefore, if a user desires to change the type of light fixture on the track, the user must also purchase another ballast even if the old ballast still functions.

### SUMMARY OF THE INVENTION

The foregoing problems are solved and a technical advance is achieved by the present invention. Disclosed is a ballast housing detachably attached to a track having a removable attachment for a lighting fixture.

BRIEF DESCRIPTIONS OF THE DRAWINGS

The invention and further features and advantages thereof are explained in greater detail on the basis of the exemplary embodiments schematically shown in the figures.

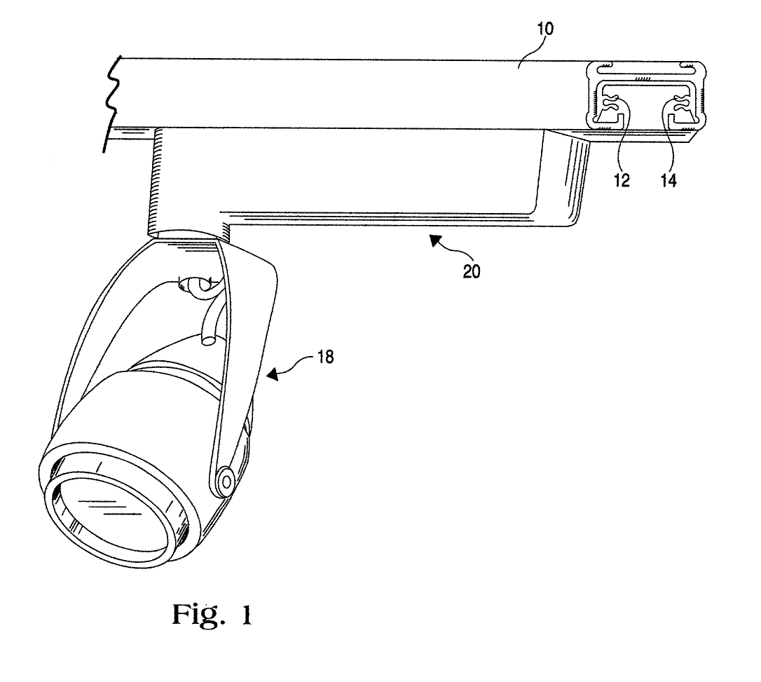

FIG. 1 is a perspective view of a track lighting system having a track, a ballast housing, and a lighting fixture.

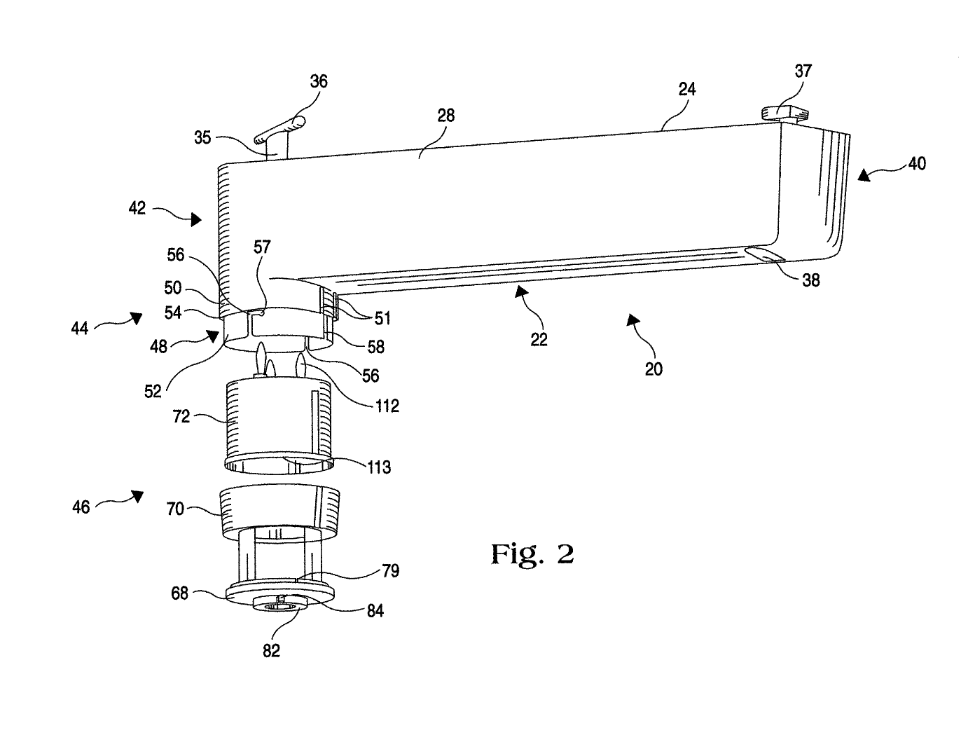

FIG. 2 is a perspective exploded view of the ballast housing and the male connector of the present invention.

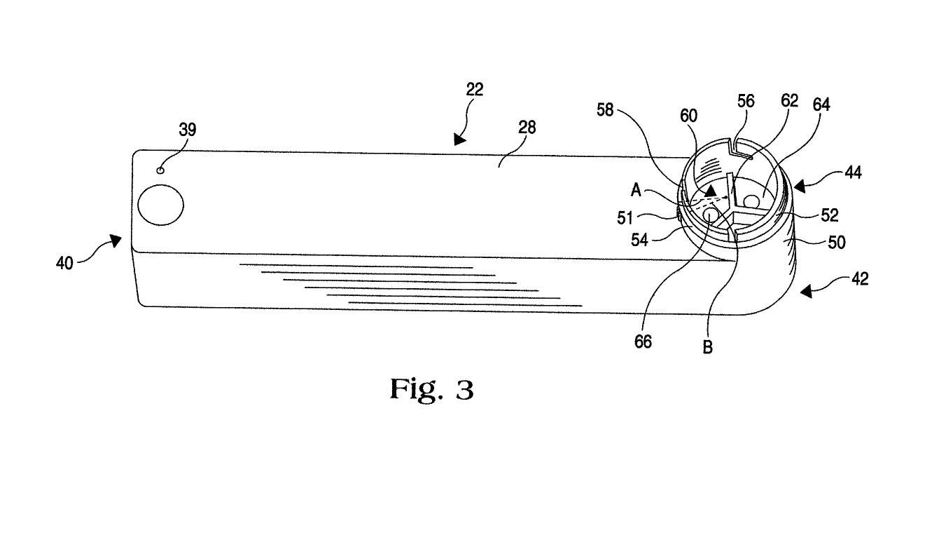

FIG. 3 is a top perspective view of the ballast housing of the present invention.

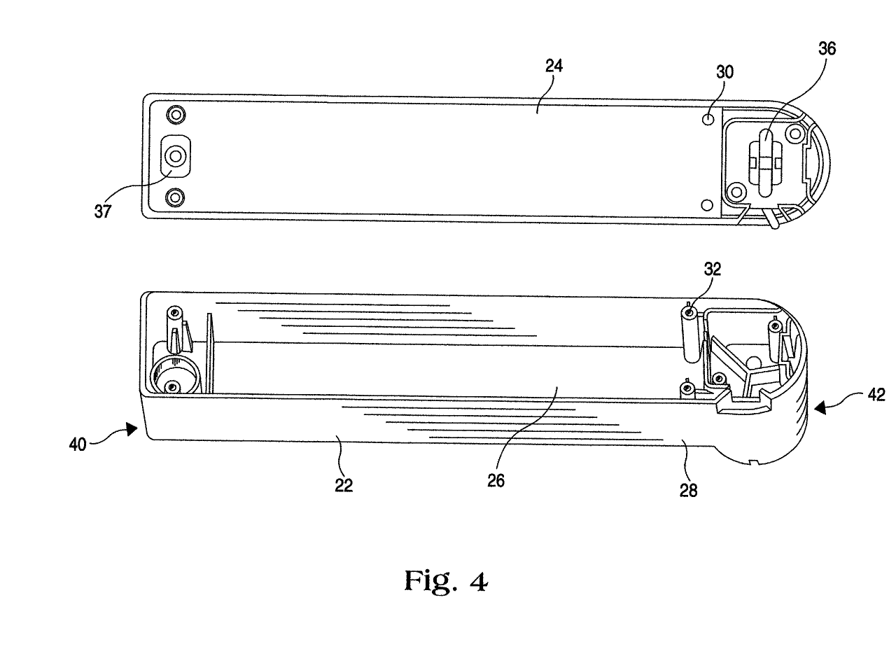

FIG. 4 is a bottom perspective view of the base portion and the cover plate of the ballast housing shown in a removed position.

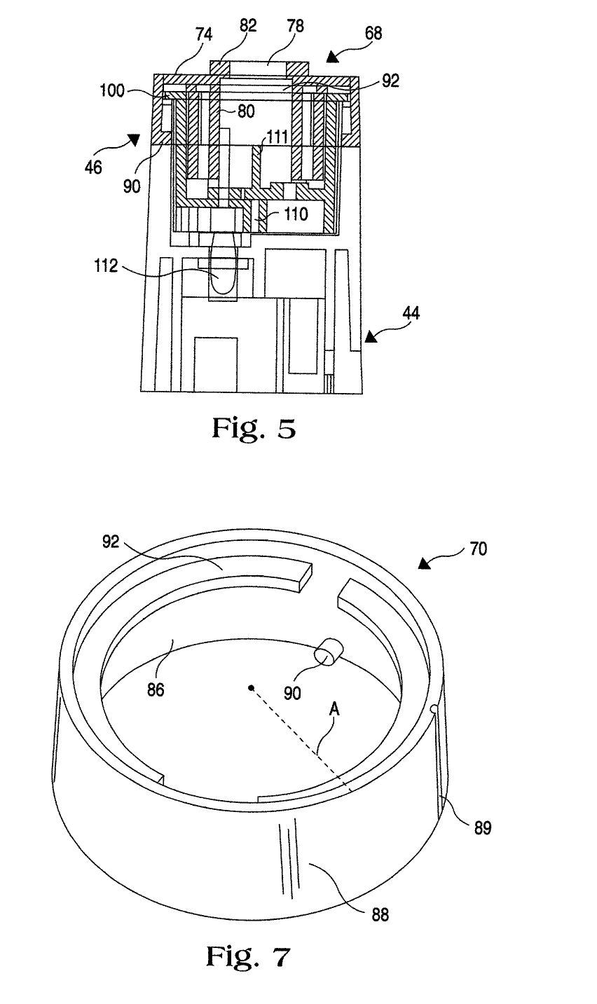

FIG. 5 is a cross-sectional view of the male connector releasably engaged with the female connector of the present invention.

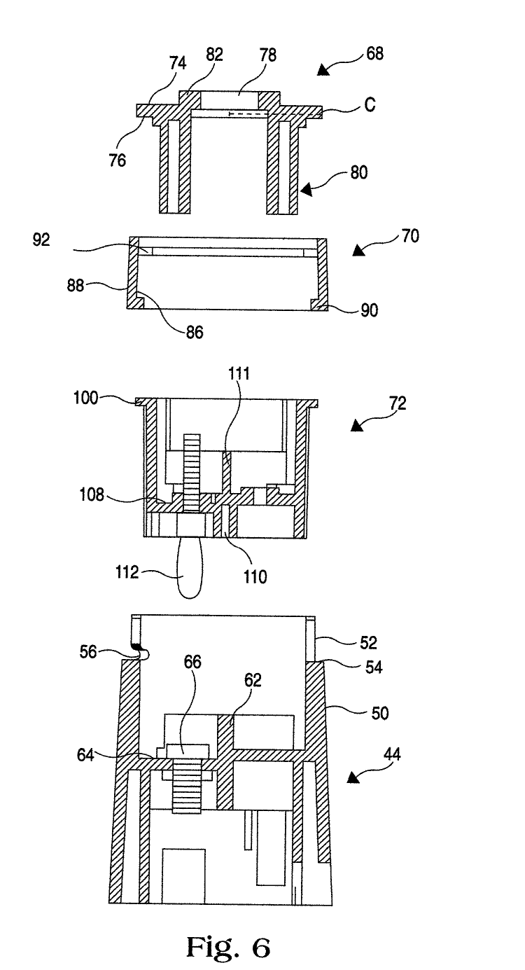

FIG. 6 is an exploded cross-sectional view of the male connector and female connector of the present invention.

FIG. 7 is a top perspective view of the locking element of FIG. 6.

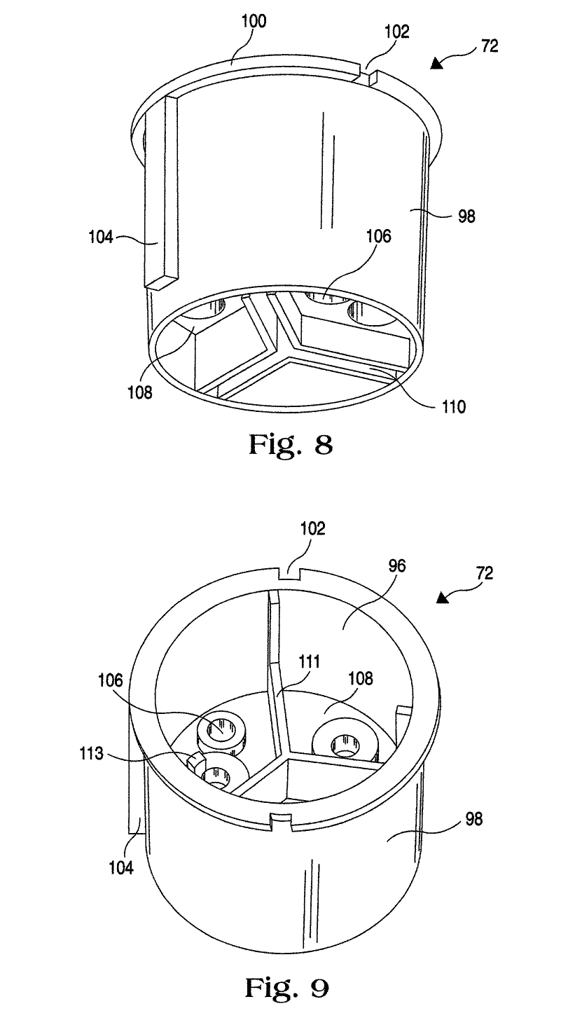

FIG. 8 is a bottom perspective view of the adapter element of FIG. 6.

FIG. 9 is a top perspective view of the adapter element of FIG. 6.

### DETAILED DESCRIPTION

Referring to the drawings in more detail, FIG. 1 illustrates a track 10 of a track lighting system adapted for mounting on a surface, such as a ceiling (not shown). Electrical conductors line the track 10 to provide a source of electric power (not shown) typically in the form of wires or bus bars. In one embodiment, there are at least two extrusion of the track 10 itself can act as the ground connection, as is customary. In some embodiments, three separate wires or bus bars are provided. The track 10 provides slidable support for at least one lighting fixture 18 which may be moved to any desired position along the length of the track 10. Particularly, the track 10 provides mechanical support and electrical grounding for the lighting fixture 18. The track 10 may be made from any type of metal or suitable material, including but not limited to extruded aluminum.

The lighting fixture 18 contains a lamp receptacle (not shown) for receiving a high intensity discharge (HID) lamp (not shown). The lamp receptacle, lamp, and wiring are not shown, as they are conventional and well known in the art. In one embodiment, the HID lamp is a ceramic arc tube metal halide high intensity discharge lamp (CAMH). The lighting fixture 18 detachably attaches to a ballast housing 20 enclosing a ballast (not shown) which provides the initial ignition and the continuing electrical current needed for HID lamps (FIG. 2). Having a ballast separate from the lighting fixture 18 permits a user to mount and remove the lighting fixture 18 without needing to remove the ballast. The ballast housing 20 may be generally rectangular in shape to substantially align with the track 10 and may be comprised of plastic or metal. In one embodiment, the ballast housing 20 is comprised of polycarbonate lexan 940.

Referring to FIGS. 2 to 4, the ballast housing 20 includes a base portion 22 and a cover plate 24. The ballast is removably inserted into the base portion 22 of the ballast housing 20 and may be secured therein and electrically connected to a power supply and to the lighting fixture 18 lamp receptacle wiring through easily detachable and reattachable connections, such as crimp connectors, in a manner as is generally known in the art to permit easy replacement of the ballast. The base portion 22 has an interior surface 26 which receives the ballast and an exterior surface 28 which detachably attaches to the lighting fixture 18. The cover plate 24 is detachably attached to the interior surface 26 of the ballast housing 20. The cover plate 24 has a plurality of openings 30 that align with a plurality of bores 32 on the interior surface 26 of the ballast housing 20. Fasteners (not shown), as are generally known in the art, engage the openings 30 and the bores 32 to securely fasten the cover plate 24 onto the base portion 22. In one embodiment, the cover plate 24 has two components, one covering the ballast and the other covering the electrical components of the female and male connectors 44 and 46, respectively. The base portion 22 of the ballast housing 20 mechanically and electrically contacts the ballast housing 20 to the track 10 through a set of fingers 36 extending from a post 35 extending from the interior surface 26 of the base portion 22 through the cover plate 24 near a proximal end 42 of the ballast housing 20. In one embodiment, two fingers 36 extend from the tower through the cover plate to detachably attach to the two electrical conductors 12 and 14 and the post 35 engages the extrusion for grounding on the track 10. At a distal end 40, a latch 38, pivotable on the exterior surface 28, is affixed to and controls the movement of a tower 37. When the latch 38 is pivoted, the tower 37 may rotate up to approximately 90 degrees to engage the track 10. A detent 39 in the exterior surface 28 catches an extension (not shown) on the latch 38 to hold the latch 38 and hence the tower 37 in the engaged position. In this position, the latch 38 is flush with the exterior surface 28 of the base portion 22. Another embodiment for mounting the fingers 36 and tower 37 in the track is described in U.S. Pat. No. 5,259,774, which is incorporated herein by reference.

Referring to FIG. 2, near the proximal end 42 of the ballast housing 20, a female connector 44 extends perpendicularly from the exterior surface 28 of the base portion 22. The female connector 44 detachably attaches to a male connector 46 which, in turn, may be detachably attached to the lighting fixture 18. The female connector 44 and the male connector 46 provide the electrical and mechanical connection between the ballast housing 20 and the lighting fixture 18. The female and male connector 44 and 46, respectively, may be comprised of plastic or metal. In one embodiment, the female connector 44 and the male connector 46 are comprised of polycarbonate lexan 940.

The female connector 44 preferably integrally forms a continuous cylindrical wall 48 from the ballast housing 20. As depicted in FIGS. 2 and 3, a lower portion 50 of the cylindrical wall 48 has a predetermined radius, A. In one embodiment, the lower portion 50 has preferably two vertical indents or raised lines 51. At approximately the midpoint of the height of the cylindrical wall 48, an upper portion 52 of the cylindrical wall 48 has a smaller radius B which forms a ledge 54 at the junction of the lower portion 50 and the upper portion 52 in the cylindrical wall 48. At least one bayonet slot 56 is formed in the upper portion 52 of the cylindrical wall 48. In one embodiment, two “L”-shaped bayonet slots 56 are formed in the upper portion 52 of the cylindrical wall 48 and are spaced approximately 180 degrees apart (for example). Additional bayonet slots 56 may be provided as well. The bayonet slots 56 may have a detent 57 in the bottom portion of the “L”. Further, a keyway 58 may be placed on the upper portion 52 of the cylindrical wall 48 to assure a correct polarity of the electrical connection. Inside the cylindrical wall 48 is a cavity 60 of a predetermined depth. In one embodiment, a “Y”-shaped partition wall 62 extends above a floor 64 of the cavity 60 to increase voltage carrying capacity. The partition wall 62 may be angled asymmetrical for reasons described below. Inside each area is a single socket 66. One skilled in the art would recognize that any number of partitions 62, including none, and two or more sockets 66 may be employed in the electrical connection.

Referring back to FIG. 2, the male connector 46 has three separate components which lock the lighting fixture 18 to the ballast housing 20: a yoke element 68, a locking element 70, and an adapter element 72. The three pieces align with one another in the sequence just described. As depicted in FIGS. 5 and 6, the yoke element 68 has a top face 74 and a bottom face 76 having an outer radius, C. An opening 78 lies in the center of the yoke element 68 to receive the wiring (not shown) of the lighting fixture 18. In one embodiment, an eyelet (not shown) is non-rotatably mounted in the opening 78 to securedly attach the lighting fixture 18 to the yoke element 68. A gap 79 (FIG. 2) is cut out of the outer circumference of the yoke element 68, which provides a guide for the yoke element 68 when the yoke element 68 is aligned with the adapter element 72. Two enclosed bores 80 extend downward from the bottom face 76 of the yoke element 68. A rotation ring 82 with a rotation stop 84 extends from the top face 74 around the circumference of the opening 78 (FIG. 2). The bores 80 receive fasteners (not shown) which fasten the yoke element 68 to the adapter element 72 and prevent movement of the yoke element 68 relative to the adapter element 72. The yoke element 68 rests on the locking element 70 as described below.

Referring to FIGS. 6 and 7, the locking element 70 has an inner wall 86 and an outer wall 88. The locking element 70 has an inner radius slightly larger than C to receive the yoke element 68. At least one bayonet pin 90 protrudes from the inner wall 86. In one embodiment, two bayonet pins 90 located approximately 180 degrees apart protrude from the inner wall 86, although different numbers of pins or different angles may be chose, so long as they are arranged complementarily to the bayonet slots 56. The bayonet slots 56 of the upper portion 52 of the female connector 44 receive the two bayonet pins 90. The detents 57 retain the bayonet pins 90 in a locked position when the male connector 46 is assembled for use. The outer wall 88 may also have an indent or raised line 89 that aligns with either of the two indents 51 of the lower portion 50 of the cylindrical wall 48 of the female connector 44 to form a continuous indent or line as the locking element 70 is rotated between a locked position and an unlocked position. In one embodiment, the indents 51 are marked “lock” and “unlock” to designate the two positions in which the bayonet pins 90 rest when in the bayonet slots 56.

As depicted in FIG. 7, a ledge 92 partially circles above the bayonet pins 90 on the inner wall 86 of the locking element 70 to provide a seat and stop for the yoke element 68. The locking element 70 has an outer radius equal to the radius, A, so that when the male connector 46 aligns with the female connector 44, the lower portion 50 of the cylindrical wall 48 is continuous with the outer wall 88 of the locking element 70. The locking element 70 overlaps the adapter element 72 as described below. In another embodiment, the locking element 70 is threadedly engaged to the female connector 44 rather than engaged by the bayonet pins 92 and bayonet slots 56. In other embodiments, other releasable connectors as are known in the art are employed to engage the female connector 44 to the male connector 46.

Referring to FIGS. 8 and 9, the adapter element 72 has an inner portion 96 and an outer portion 98 in which a flange 100 extends from the outer portion 98 at a top end. The outside circumference of the flange 100 has a radius substantially similar to the yoke element 68 so that the ledge 92 of the locking element 70 rests on the flange 100 to prevent movement of the adapter element 72 through the locking element 70. Therefore, when all three components of the male connector 46 are placed together, the ledge 92 sits between the yoke element 68 and the adapter element 72. At least one flange opening 102 of the adapter element 72 permits the bayonet pin 90 of the locking element 70 to bypass the flange 100 of the adapter element 72. In one embodiment, the two bayonet pins 90 bypass two flange openings 102. A key 104 extends down the outer portion 98 of the adapter element 72 perpendicular to and continuous with the flange 100. The key 104 engages the keyway 58 of the female connector 44 to prevent rotation and provide proper alignment of the adapter element 72 relative to the female connector 44.

The inner portion 96 of the adapter element 72 has two openings 106 through a horizontal floor 108 to receive and guide fasteners into the bores 80 of the yoke element 68 to clamp the locking element 70 between the yoke element 68 and the adapter element 72 but not so tight as to prevent rotation. As a result, rotational movement of the yoke element 68 relative to the adapter element 72 and the female connector 44 is prevented. Electrical pins 112 extend through the floor 108 of the adapter element 72 to engage the sockets 66 of the female connector 44 (FIG. 6). The floor 108 of the adapter element 72 is complementarily shaped to receive the floor 64 of the female connector 44. In one embodiment, a “Y” shaped recess 110 receives the “Y” shaped partition wall 62 of the female connector 44. The recess 110 is similarly asymmetrically angled to permit only the correct alignment of the sockets 66 of the female connector 44 and the respective electrical pins 112 of the adapter element 72. The opposing side of the floor 108 of the adapter element 72 may include a “Y” shaped partition wall 111 which increases voltage carrying capacity. A post 113 extends from at least one arm of the “Y” shaped partition wall 111 and seats within the gap 79 of the yoke element 68 (FIG. 2). In one embodiment, one of three electrical pins 112 protrude through each of three areas defined by the “Y” shaped partition wall 111 of the adapter element 72.

The electrical pins 112 and the sockets 66 may be configured to assist the user in aligning the electrical pins 112 and the sockets 66 and to prevent inaccurate coupling. In one embodiment, the electrical pins 112 may be of different lengths and the sockets 66 of different depths to accommodate only the correct electrical pin 112. In another embodiment, the vertical positions of the electrical pins 112 may be varied to accomplish the same goal. For example, a ground conductor electrical pin 112 may be the first to engage and the last to disengage its respective socket 66 during the process of engaging or disengaging a lighting fixture 18 resulting in the lighting fixture 18 being grounded before power is applied. Further, the key 104 on the outer portion 98 of the adapter element 72 permits the adapter element 72 to rest in the female connector 44 in only one rotational position which also insures that the electrical pins 112 engage their respective sockets 66.

The lamp and lamp receptacle of the lighting fixture 18 connect to the male adapter 46 through conventional wiring which extends through the opening 78 of the yoke element 68 to the electrical pins 112 of the adapter element 72. As depicted in FIGS. 1 and 2, the lighting fixture 18 has a surface that abuts the yoke element 68 of the male connector 46. A stop pin (not shown) extends from the surface of the lighting fixture 18 and prevents horizontal movement beyond approximately 358 degrees when the stop pin contacts the rotational stop 84 on the yoke element 68. The configuration of the lighting fixture 18, the yoke element 68, the locking element 70, the adapter element 72 of the male connector 46, and the female connector 44 permits vertical and horizontal adjustment of the lighting fixture 18 relative to the ballast housing 20 without unlocking the lighting fixture 18 from the ballast housing 20. In one embodiment, the lighting fixture 18 rotates approximately 90 degrees vertically and approximately 358 degrees horizontally. Further, the locking element 70, which is capable of rotation, is mechanically isolated from the electrical pins 112.

Any type of lighting fixture 18 may include the male connector 46 of the present invention. Therefore, the ballast housing 20 with the integrally formed female connector 44 may detachably attach to any lighting fixture 18 having the corresponding male connector 46.

Referring to FIGS. 1 and 2, to place a ballast in the track 10 mounted on the ceiling or other horizontal, vertical or sloped surface, the ballast is inserted and electrically received in the ballast housing 20. To connect the ballast housing 20 to the track 10, the ballast housing 20 is positioned at a 90 degree angle to and below the track 10. The fingers 36 are aligned with an elongated opening in the track 10 and then the ballast housing 20 is rotated approximately 90 degrees to engage the electrical conductors 12 and 14 and the extrusion of the track 10 to complete an electric connection to the wiring of the light fixture 18, and thus, to the lamp. The latch 38 on the distal end 42 of the ballast housing 20 is then rotated approximately 90 degrees so that the tower 37 contacts the track 10. In this position, the latch 38 is placed into the detent 39 and lies flush with the exterior surface 28 of the ballast housing 20 and therefore is hidden from the view below. Engaging the tower 37 with the track 10 mechanically secures the distal end 42 to the track and prevents the fingers 36 on the proximal end 40 from rotating. Once the ballast is affixed to the track 10, the male connector 46 of the lighting fixture 18 is detachably attached to the female connector 44 of the ballast housing 20.

Depicted in FIGS. 2, 3, and 6-9, the male connector 46 is assembled so that the yoke element 68 rests on the ledge 92 of the locking element 70 and the ledge 92 rests on the flange 100 of the adapter element 72. The post 113 of the adapter element 79 is aligned with the gap 79 of the yoke element 68 to prevent rotation of the yoke element 68 and the adapter element 72 relative to one another. Once the three components are correctly aligned, the fasteners securedly attach the adapter element 72 to the yoke element 68. The bayonet pins 90 bypass the adapter element 72 through the flange openings 102. The bayonet pins 90 of the locking element 70 are then aligned with and placed in the bayonet slots 56 on the female connector 44. Further, the electrical pins 112 are placed in their respective sockets 66. The locking element 70 is rotated from approximately 10 to approximately 30 degrees to connect and secure the lighting fixture 18 to the ballast housing 20 both mechanically and electrically.

The light fixture 18 may be constructed either integral with the male connector 46 or detachably attached to the male connector 46. If the light fixture 18 is detachably attached to the male connector 46, the light fixture 18 may be attached to the male connector 46 before the male connector 46 detachably attaches to the female connector 44. The stop pin on the light fixture 18 is aligned with the yoke element 68 so that the stop pin may rotate freely up to 358 degrees around the rotation ring 82 (FIG. 5).

The male and female connectors, 46 and 44, respectively, have just been described in a configuration where the female connector 44 is associated with the ballast housing 20 and where the male connector 46 is associated with the lighting fixture 18. It is to be understood that the respective parts may be reversed as well so that the male connector 46 is associated with the ballast housing 20 and the female connector 44 is associated with the lighting fixture 18. Also, although the female connector 44 is illustrated as having a cylindrical wall 48, the wall could be of other configurations, such as rectangular, particularly if locking arrangements other than bayonets slots 56 or threaded connections are utilized, such as other snap locks or latches as are known in the art.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

I claim:

1. A ballast housing, comprising:
(a) a base portion having an interior surface and an exterior surface, the interior surface of the base portion configured to detachably receive a ballast;
(b) one of a female connector and a male connector extending from the exterior surface of the base portion, wherein one of the female connector and the male connector is configured to releasably engage the other of the female connector and the male connector detachably attached to a lighting fixture.

2. The ballast housing of claim 1, further comprising a cover plate configured to detachably attach to the interior surface of the base portion.

3. The ballast housing of claim 1, wherein the interior surface of the base portion further comprises at least one tower configured to detachably attach the ballast housing to a track.

4. The ballast housing of claim 3, wherein the exterior surface of the base portion further comprises a latch configured to rotate the at least one tower to detachably attach the ballast housing to the track.

5. The ballast housing of claim 1, wherein one of the female connector and the male connector further comprises a cylindrical wall.

6. The ballast housing of claim 5, wherein the cylindrical wall further comprises at least one bayonet slot configured to receive at least one bayonet pin of the other of the female connector and the male connector.

7. The ballast housing of claim 1 wherein the female connector further comprises a cavity having at least two sockets configured to engage at least two electrical pins of the male connector.

8. The ballast housing of claim 7, wherein the cavity further comprises a floor having a partition wall configured to increase voltage carrying capacity.

9. A connector assembly for a lighting fixture apparatus, comprising:
(a) a male connector provided at one of a lighting fixture and a ballast housing; and
(b) a female connector provided at the other of the lighting fixture and the ballast housing;
wherein the female connector is configured to releasably engage the male connector.

10. The connector assembly of claim 9, wherein the female connector further comprises a cylindrical wall.

11. The connector assembly of claim 10, wherein the cylindrical wall further comprises at least one bayonet slot.

12. The connector assembly of claim 9, wherein the female connector further comprises a cavity having at least two sockets.

13. The connector assembly of claim 12, wherein the cavity further comprises a floor having a partition wall configured to separate the at least two sockets.

14. The connector assembly of claim 10, wherein the cylindrical wall further comprises a keyway.

15. The connector assembly of claim 9, wherein the male connector further comprises a yoke element having a predetermined radius, C.

16. The connector assembly of claim 15, wherein the male connector further comprises a locking element configured to releasably engage the female connector.

17. The connector assembly of claim 16, wherein the female connector further comprises a cylindrical wall having a predetermined radius, A.

18. The connector assembly of claim 17, wherein the locking element has an exterior radius substantially equal to the radius, A.

19. The connector assembly of claim 15, wherein the male connector further comprises an adapter element having electrical pins configured to releasably engage the at least two sockets of the female connector.

20. The connector assembly of claim 16, wherein the locking element has an inner radius slightly larger than the radius, A, of the yoke element.

21. The connector assembly of claim 15, wherein the yoke element further comprises a rotation ring and a rotation stop.

22. The connector assembly of claim 21, wherein the rotation ring and the rotation stop are configured to permit up to approximately 358 degrees of horizontal rotation of the lighting fixture relative to the male connector.

23. The connector assembly of claim 17, wherein the cylindrical wall further comprises at least one bayonet slot.

24. The connector assembly of claim 23, wherein the locking element further comprises at least one bayonet pin configured to engage the at least one bayonet slot of the female connector.

25. The connector assembly of claim 24, wherein the locking element further comprises two bayonet pins located approximately 180 degrees apart.

26. The connector assembly of claim 16, wherein the locking element further comprises a ledge configured to provide a seat for the yoke element.

27. The connector assembly of claim 19, wherein the adapter element further comprises a flange having a radius substantially similar to the yoke element.

28. The connector assembly of claim 19, wherein the adapter element further comprises a key configured to engage a keyway of the female connector.

29. The connector assembly of claim 19, wherein the adapter element further comprises a floor having a recess configured to receive a partition wall of the female connector.

30. The connector assembly of claim 19, wherein the electrical pins and the sockets are configured to first engage a ground conductor electrical pin.

31. A lighting fixture apparatus, comprising:
(a) a lighting fixture;
(b) a ballast housing configured to receive a ballast;
(c) a male connector provided at one of the lighting fixture and the ballast housing; and
(d) a female connector provided at the other of the lighting fixture and the ballast housing;
wherein the female connector and the male connector are configured to be releasably engaged.

32. The lighting fixture apparatus of claim 31, wherein the female connector further comprises a cavity having at least two sockets.

33. The lighting fixture apparatus of claim 32, wherein the cavity further comprises a floor having a partition wall configured to increase voltage carrying capacity.

34. The lighting fixture apparatus of claim 33, wherein the male connector further comprises an adapter element having electrical pins configured to releasably engage the at least two sockets of the female connector.

35. The lighting fixture apparatus of claim 34, wherein the adapter element further comprises a floor having a recess configured to receive the partition wall of the female connector.

36. The lighting fixture apparatus of claim 34, wherein the electrical pins and the at least two sockets are configured to first engage a ground conductor electrical pin.

37. A method of attaching a lighting fixture to a ballast housing, comprising the steps of:
(a) providing the ballast housing with one of a male connector and a female connector;
(b) providing the light fixture with the other of the male connector and the female connector; and
(c) removably engaging the male connector with the female connector to attach the lighting fixture to the ballast housing.

38. The method of claim 37, further comprising mounting the ballast housing to a track.

39. The method of claim 38, wherein mounting the ballast housing to the track further comprises aligning at least one finger with the track.

40. The method of claim 39, wherein aligning the at least one finger with the track further comprises rotating the ballast housing approximately 90 degrees.

41. The method of claim 38, wherein mounting the ballast housing to the track further comprises aligning at least one tower with the track.

42. The method of claim 41, wherein aligning the at least one tower with the track further comprises rotating a latch approximately 90 degrees.

43. The method of claim 42, wherein aligning the at least one tower with the track further comprises placing the latch in a detent on the ballast housing.

44. The method of claim 37, wherein the step of providing the male connector further comprises placing a yoke element on a ledge of a locking element.

45. The method of claim 44, wherein the step of providing the male connector further comprises placing the ledge on a flange of an adapter element.

46. The method of 45, wherein the step of providing the male connector further comprises aligning a post of the adapter element with a gap of the yoke element.

47. The method of claim 45, wherein the step of providing the male connector further comprises securedly attaching the adapter element to the yoke element.

48. The method of claim 44, wherein removably engaging the male connector to the female connector further comprises aligning bayonet pins of the locking element with bayonet slots on the female connector.

49. The method of claim 44, wherein removably engaging the male connector to the female connector further comprises rotating the locking element from approximately 10 to approximately 30 degrees.

50. The method of claim 37, wherein removably engaging the male connector to the female connector further comprises first engaging a ground conductor electrical pin of the male connector in a socket of the female connector.
